(19) United States
(12) Patent Application Publication
(10) Pub. No.: US 2002/0163466 A1
(43) Pub. Date: Nov. 7, 2002

(54) Method and apparatus for synchronization of clocks

(76) Inventor: Lin Jin, Beijing (CN)

Correspondence Address: Lawrence S. Cohen, Suite 1220, 10960 Wilshire Boulevard, Los Angeles, CA, 90024, US

(21) Appl. No.: 10/083,843

(22) Filed: Feb. 27, 2002

Related U.S. Application Data
(60) Provisional application No. 60/271,950, filed on Mar. 1, 2001.

(51) Int. Cl. G04C 11/02; H04L 7/00; H04B 7/19

(52) U.S. Cl. 342/356; 368/47; 375/354

(57) ABSTRACT

Clocks are synchronized using a reference clock in two possible ways. One method uses two-way communication between a reference clock and a moving clock. The other method uses one-way communication from the moving clock.

### RELATED APPLICATION

This application is based on provisional application serial No. 60/271,950 filed on Mar. 1, 2001 and claims priority of that date. The entire content of the provisional application is incorporated herein by reference.

### FIELD OF THE INVENTION

This application relates to the synchronization of clocks using, in one application, signals from orbiting satellites such as in the Global Positioning System (GPS) and GLONASS.

### BACKGROUND OF THE INVENTION

In industry there is a business segment which provides electronic devices which yield precise time. Some of these devices derive high precision time through a transfer process whereby they transfer time from a satellite system. One such satellite system is the Global Positioning System (GPS). Various manufacturers use GPS receivers in which precise time is derived from one of the atomic clocks in the satellites (GPS Time Receiver). These are known by various names such as GPS Time Receivers, Time & Frequency Standards, and other names. Sometimes they also provide precise frequency measurement. Such Time Receivers are sold for a variety of applications where precise time is important. In certain applications there is a need to synchronize these Time Receivers with each other. One such application area is the synchronization of telecommunications signals. The synchronization process is handled in a number of conventional ways.

When satellite clocks are required to be instantaneously synchronized with each other at the nanosecond level difficulties arise due to the misapplication or misinterpretation of the relativistic effects and gravity effects between a moving clock in a satellite and a stationary Time Receiver on the ground. This invention is a new and non-traditional method for performing a synchronization process that enables instantaneous synchronization of such Time Receivers (clocks) to a high level of precision. One use of this invention could be to modify an existing clock to perform the synchronization process defined in this patent application.

As refered to above, the problem addressed in this disclosure is the instantaneous synchronization of two or more clocks located at different positions in a given spatial coordinate system, by means of either two-way or one-way radio communication between clocks. Generally, some or all of the clocks will be in motion relative to that coordinate system. In a typical application the coordinate system is attached to the earth, and some of the clocks would be on the surface of the earth, while others would be in satellites orbiting the earth. The satellite clocks would typically be atomic (Rubidium or Cesium), and the earthbound clocks might be either crystal oscillator or atomic.

When some of the clocks are in moving satellites, in one aspect of the inventio, synchronization requires that relativistic effects be taken into account.

Einstein's theory of Special Relativity is based on two postulates. The first is commonly called the relativity postulate, which states that for any two inertial frames in uniform relative motion, the laws of physics within each frame are identical. The second postulate is that the speed of light is constant, regardless of the inertial frame in which it is measured.

Einstein showed that if both postulates are assumed, that neither time nor distance is absolute. Specifically, if measurements of the time interval and/or distance between two events in space-time are made within each of two inertial frames in relative motion, the measurements will differ.

The non-absolute nature of time posited by the Special Theory of Relativity poses complications in the process of time synchronization, and has led to errors resulting from misapplication of the Special Theory.

The invention described herein removes the complications imposed by the Special Theory, by assuming only the first of Einstein's two postulates to produce a space-time theory in which time can be regarded as absolute. As a consequence, distance and velocity are defined somewhat differently, but the process of time synchronization is made extremely simple.

### SUMMARY OF THE INVENTION

In one aspect the invention is a method for synchronizing one clock to another clock or a plurality of clocks to a given clock; in one particular case where one clock defined as a reference clock is on the earth and another clock is in a satellite which is in translatory motion relative to the reference clock. In that case, the method is to synchronize the satellite clock to the reference by making measurements of times of transmissions and arrival of a sequence of two-way transmissions and using those measurements deriving a correction term to be applied to the satellite clock. In one aspect of this case, the satellite clock is reset ascending to the correction and in another aspect of this case the correction term is used along with the satellite clock reading. Further, in the latter aspect the correction term may be applied in the satellite and a corrective time broadcast or in an alternative the satellite time and the correction term are both broadcast to user equipment which performs the correction.

Another primary aspect of the invention is referenced to as one-way communication, meaning communication from a satellite to two or more ground stations whose clocks are designed to be synchronized. For convenience, one of the ground stations is designated as the reference station or clock. Notably, where there is a plurality of ground stations, they can all be synchronized to the reference station simultaneously, or by designated groups or serially, depending on the communication system between the reference station and the other stations. In the one-way communication aspect first a corrective term representing difference in time reading between the reference station and the satellite is obtained, then a corrective term representing the difference in time reading between the next station, or stations and the satellite is obtained, then the difference between the corrective term is obtained, one that difference is applied to the station (clock) to be synchronized to the reference station.

In another aspect, applied to a specific system such as GPS, the invention is implemented between a GPS ground control station and the satellite to determine a correction term for each satellite. Then the satellite can use the corrective term locally (at the satellite or broadcast it along with a time signal so that the correction calculation is done by the user).

### BRIEF DESCRIPTION OF DRAWINGS

FIG. 1 SpaceTime diagram for synchronization using two-way communication

FIG. 2 Correction (synchronization) of satellite clock using two-way communication and subsequent synchronization of a clock C

FIG. 3 SpaceTime diagram for synchronization of clocks using one-way communication

FIG. 4 Synchronization of clocks using one-way communication

FIG. 5 Flowchart for synchronization using one-way communications

FIG. 6 Apparatus for synchronization of clocks using one-way communication.

### DETAILED DESCRIPTION

Following are descriptions of methods and apparatus for synchronizing clocks according to the invention.

In describing the synchronization process, it is convenient to regard one of the clocks as a reference to which other clocks will be synchronized. This reference clock will be called clock A in the following discussion. In some applications, clock A is located on the surface of the earth, and the clocks to be synchronized are either on the surface of the earth or in satellites orbiting the earth. Also clock A could be located in an orbiting satellite. However, for convenience of the explanation, clock A is described as being located on the surface of the earth.

If another clock is to be synchronized to clock A, and there are no other clocks available, then two-way line-of-sight radio transmissions may be employed to synchronize the second clock, but one-way transmissions are not enough to accomplish this unless additional information is available. It is also necessary that the clocks be visible to each other. On the other hand, it may be possible for the second clock to be synchronized with only one-way transmissions from a third clock which has both clock A and the second clock in view, even if the latter two clocks are not be visible to each other. This will generally require that the third clock broadcast certain information regarding its position and events (epochs) of signal transmission as a function of time. Such is the case if the third clock is located in a Global Positioning System (GPS) satellite or a GLONASS satellite.

Synchronization Using Two-Way Radio Transmissions

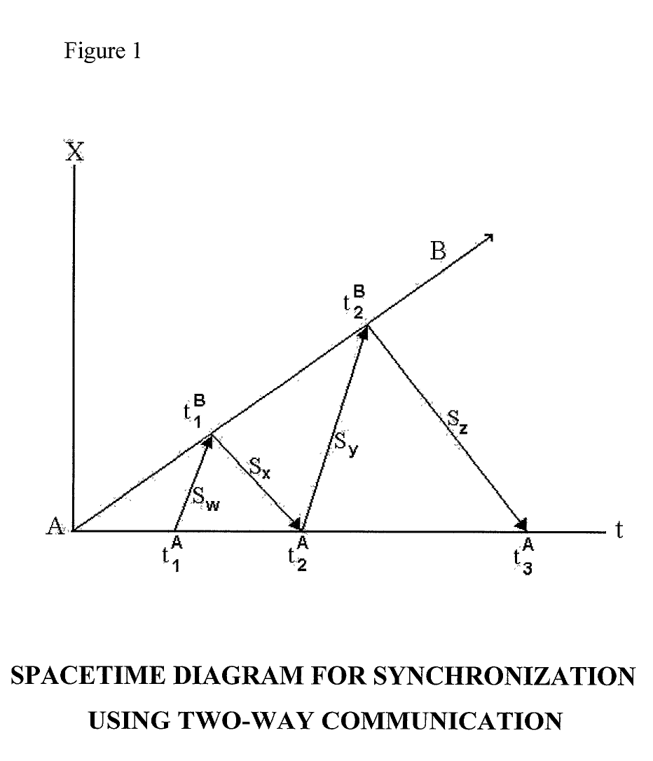

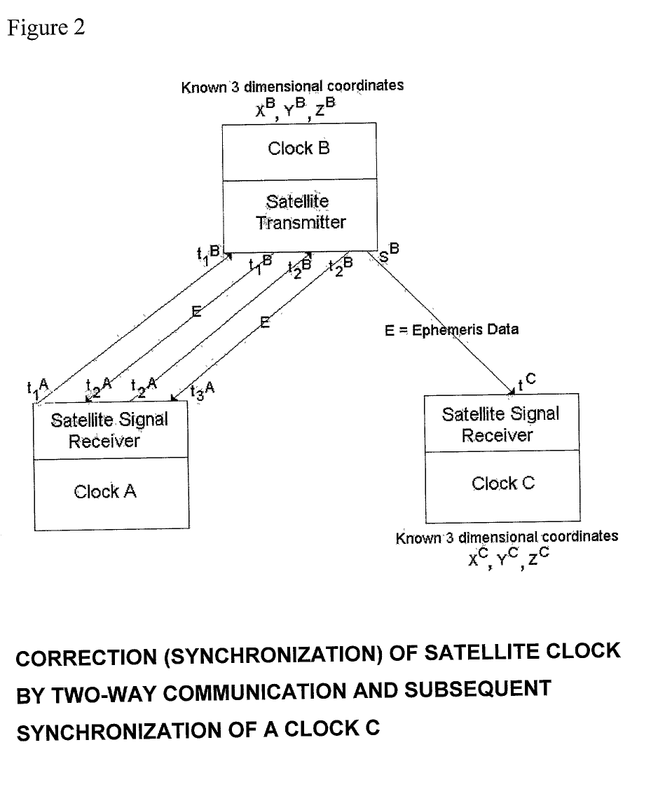

Understanding of the following explanation will be aided by referring to FIGS. 1 and 2. Consider the case involving three clocks, denoted by A, B, and C. Clock A is considered to be the reference clock, and clocks B and/or C are to be synchronized to clock A. Clocks A and C are visible from clock B, but clocks A and C may not be visible to each other. Although clocks B and C might be moving relative to clock A, we assume here that clock C is fixed relative to clock A, and that clock B has uniform motion relative to the other two clocks.

Co-located with each clock is a radio station and a computer. It is assumed that the radio station in clock A is capable of two-way communication with the radio station in clock B, and that clock B can send a one-way signal to clock C. For notational simplicity, the letters A, B, and C will also be used to identify the locations of the clocks, as well as the radio stations/computers associated with each clock.

Clocks A and C are assumed to be at rest with precisely known locations within a 3-dimensional inertial (i.e. non-accelerating) coordinate system, and clock B has uniform translatory motion (i.e., constant velocity) relative to the inertial system. All three clocks are identical in the sense that they would run at precisely the same rate if they were all stationary within the same inertial frame. However, the clocks may have been initialized differently, so their times may not agree.

We first describe the two-way synchronization of clock B to clock A followed by a synchronization of clock C to clock B, from which a synchronization of clock A to clock C can be established. The synchronization process uses absolute time within the new space-time model described above.

Measurement of Relative Motion

Before synchronization can be achieved, measurements must be made which characterize the radial velocity of clock B relative to clock A. These measurements are made using clocks A and B, and do not involve clock C. An important parameter needed for the synchronization process is called the characteristic parameter of relative motion, and is denoted by ξ. This parameter is a measure of the relative radial velocity of clocks A and B, which is the rate at which the distance between A and B is changing with respect to time. To define ξ, assume that A sends two signals to B which are spaced Δt_{A} seconds apart according to clock A. Due to the relative motion of clocks A and B, the two signals will generally arrive at clock B with a different time spacing as measured by clock B. The parameter ξ is simply the ratio of the latter time spacing to the former, i.e., the two signals arrive with time spacing ξΔt_{A} according to clock B. Because the relative motion of A and B is uniform, ξ does not depend on the times that the two signals were transmitted from A; in particular ξ does not depend on Δt_{A}. Note that if there is no relative motion between A and B, then the time spacing between the two signal arrival times is equal to the spacing between the transmission times; in this case, ξ=1.

On the other hand, suppose that the direction of signal transmissions is reversed, so that B sends two signals to A which are spaced Δt_{B} seconds apart according to clock B. According to the relativity postulate, the symmetry of relative motion of A and B will result in the two signals arriving at clock A with time spacing ξΔ_{B} according to clock A.

The parameter ξ can be determined from a sequence of measurements made by sending radio signals back and forth between A and B. This process is diagrammed in FIG. 1. Suppose a radio signal S_{w} is transmitted from A at time t₁^{A} according to clock A, with the time of transmission t₁^{A} as a message for B. The signal S_{w} is received at B at time t₁^{B} according to clock B. B instantly records t₁^{A} and t₁^{B}, and simultaneously transmits back to A a signal S_{X} containing time t₁^{B} as a message for A. The signal S_{X} is received at A at time t₂^{A} according to clock A. A instantly records t₁^{B} and t₁^{A} and simultaneously transmits back to B a signal S_{y} containing time t₂^{A} as a message for B. The signal S_{y} is received at B at time t₂^{B} according to clock B. B instantly records t₂^{A} and t₂^{B}, and simultaneously transmits back to A a signal S_{Z} containing t₂^{B} as a message for A. This signal arrives at A at time t₃^{A} according to clock A. At this point in time, A has knowledge of t₁^{B}, t₂^{A}, t₃^{A},t₁^{B}, and t₂^{B}, which constitute all the basic measurements needed to establish the relative motion parameter ξ. It should be noted that B also knows all of these measurements, except for t₂^{A}, and could have knowledge of t₃^{A} by an additional message transmitted from A. From the definition of ξ given above, we see that

$$ξ = \frac{{t}_{2}^{B} - {t}_{1}^{B}}{{t}_{2}^{A} - {t}_{1}^{A}} = \frac{{t}_{3}^{A} - {t}_{2}^{A}}{{t}_{2}^{B} - {t}_{1}^{B}} . \qquad ( 1 )$$

Since ξ depends only on the ratio of time differences, it is independent of how the clocks were initialized, so that it can be determined before any attempt has been made to synchronize clock B to clock A. Taking the product of the two expressions for ξ above and taking the square root, we can obtain an expression for ξ in terms of only the reception times at clock A:

$$ξ = {( \frac{{t}_{3}^{A} - {t}_{2}^{A}}{{t}_{2}^{A} - {t}_{1}^{A}} )}^{\frac{1}{2}} . \qquad ( 2 )$$

Definition of Synchronization

The process of determining ξ normally can be done so rapidly that the relative radial velocity of clocks A and B can be considered constant during the interval that the measurements are being taken. If the relative radial velocity of clocks A and B thereafter remained constant and nonzero, at some point in time (possibly prior to the measurements described above) the distance between A and B would be zero, i.e., the clocks would coincide. Such an event is fictional, because the trajectories of the clocks will never permit them to be at the same position at any point in time. However, by assuming a constant relative radial velocity we can define the fictional moment of spatial coincidence which is useful in defining synchronization. We define clocks A and B to be synchronized if they would indicate exactly the same time at this fictional moment of coincidence (the situation when A and B have no relative motion will be dealt with later).

In the above sequence of signal transmissions and receptions, the times t₁^{B} and t₂^{B} are measurements made by clock B before it has been synchronized. If B were synchronized to A, the time readings t₁^{B} and t₂^{B} would become s₁^{B} and s₂^{B} (“s” is used to denote “synchronized”), but t₁^{A}, t₂^{A}, and t₃^{A} would remain the same. Clock B can be synchronized by resetting it so that it would read s₁^{B} at the moment it would otherwise read t₁^{B}. This is accomplished by determining s₁^{B}, which determines the correction s₁^{B}−t₁^{B} that needs to be applied, defined as ε^{B}.

One determines s₁^{B} by assuming the clocks were synchronized, so that each would indicate the same time t₀ at the fictional moment of spatial coincidence. Imagine that A sends a radio signal at that very moment. The signal is simultaneously received at B at time t₀ according to synchronized clock B. Let us also consider the signal sent by A at time t₁^{A} and received at unsynchronized time t₁^{B}, as previously discussed. This reception time is s₁^{B} according to synchronized clock B. Using the definition of ξ, we have

$$ξ = \frac{{s}_{1}^{B} - {t}_{0}}{{t}_{1}^{A} - {t}_{0}} . \qquad ( 3 )$$

On the other hand, still assuming the clocks synchronized, imagine that at the moment of coincidence, B sends a radio signal at time to according to clock B. The signal is simultaneously received at A at time t₀ according to clock A. Let us also consider the signal sent by B at unsynchronized time t₁^{B} and received by A at time t₂^{A}, as previously discussed. The transmission time is s₁^{B} according to synchronized clock B. Again, according to the definition of ξ, we have

$$ξ = \frac{{t}_{2}^{A} - {t}_{0}}{{s}_{1}^{B} - {t}_{0}} . \qquad ( 4 )$$

Taking the product of expressions (3) and (4), we obtain

$$\begin{matrix}{ξ}^{2} = \frac{{t}_{2}^{A} - {t}_{0}}{{t}_{1}^{A} - {t}_{0}} . \\ T h e n , & ( 5 ) \\ {t}_{0} = \frac{1}{{ξ}^{2} - 1} ( {ξ}^{2} {t}_{1}^{A} - {t}_{2}^{A} ) . & ( 6 )\end{matrix}$$

Substituting (6) back into (3) and performing algebraic simplification results in a solution for the value that s₁^{B} that t₁^{B} hould have if clocks A and B were synchronized:

$${s}_{1}^{B} = \frac{1}{ξ + 1} ( {t}_{2}^{A} + ξ {t}_{1}^{A} ) . \qquad ( 7 )$$

Note that if there is no relative motion between A and B, then expression (7) will still give a correct value for s₁^{B} by using ξ=1, even though there may be no point in time where clocks A and B coincide.

It can now be seen that as soon as t₁^{A}, t₁^{B}, and t₂^{A} and t₂^{B} have been measured, the parameter ξ can be computed from (1), and then s₁^{B} can be computed from (7). Synchronization of clock B can be accomplished in two equivalent ways:

Method 1: Add the correction term ε^{B}=s₁^{B}−t₁^{B} to any unsynchronized reading of clock B.

Method 2: Reset clock B by incrementing its indicated time by ε^{B} seconds.

After synchronization is achieved, we now regard time as absolute, i.e., we freely use times observed by clocks A and B to calculate distances and velocities in the same way that would be done in a Newtonian system, that is, one in which relativistic time and distance dilation is ignored.

At this point we assume clock B has been synchronized by method 2 above. After the clock is reset, its time readings will be denoted with s rather than t. For example, clock B's reading of t₁^{B} at the instant of reception of the signal S_{w} sent by A is replaced by s₁^{B}. Without loss of generality, we may also assume that t₀=0 in expression (6), since the value of t₀ never appears in expression (7).

Define the starred distance d₁^{AB*} from A to B at the instant S₁^{B} of reception of the signal sent by A at time t₁^{A}, as follows:

d₁^{AB*}=c(s₁^{B}−t₁^{A}), (8)

where c is the velocity of light in the 3-dimensional coordinate system as it travels from A to B.

After substituting expression (7) for s₁^{B} into (8), we obtain the alternate expression

$${d}_{1}^{A B *} = \frac{c}{ξ + 1} ( {t}_{2}^{A} - {t}_{1}^{A} ) . \qquad ( 9 )$$

Now define the starred radial velocity vᵣ^{AB*} between A and B as follows:

$$\begin{matrix}{v}_{r}^{A B *} = \frac{{d}_{1}^{A B *}}{{s}_{1}^{B}} = \frac{c}{ξ + 1} ( {t}_{2}^{A} - {t}_{1}^{A} ) / \frac{1}{ξ + 1} ( {t}_{2}^{A} + ξ {t}_{1}^{A} ) \\ = c {t}_{2}^{A} - \frac{{t}_{1}^{A}}{{t}_{2}^{A} + ξ {t}_{1}^{A}}\end{matrix} . \qquad ( 10 )$$

An alternate expression for vᵣ^{AB*} can be obtained by substituting t₀=0 in (5) to obtain

$$\frac{{t}_{2}^{A}}{{t}_{1}^{A}} = {ξ}^{2} , \qquad ( 11 )$$

and then substituting into (10) to obtain

$${v}_{r}^{A B *} = c \frac{ξ - 1}{ξ} . \qquad ( 12 )$$

With starred radial velocity defined, the starred distance from A to B at an arbitrary time t^{B} according to clock B is given by

d^{AB*}=vᵣ^{AB*}s^{B}, (13)

where uniform translatory motion is assumed.

It should be noted that the above definitions of starred position and starred radial velocity are different from those that would normally be used within an inertial frame. An important consequence of these nontraditional definitions is that the speed of light in propagating from A to B (uplink speed) has the traditional value c, but the speed from B to A (downlink speed) is c−vᵣ^{AB*}. This can be shown as follows: Treating time as absolute, the downlink speed of light c^{*} is

$${c}^{*} = \frac{distance between A and B at time {s}_{1}^{B}}{propagation time from B to A} = \frac{{d}_{1}^{{AB}^{*}}}{{t}_{2}^{A} - {s}_{1}^{B}} . \qquad ( 14 )$$

Substitution of expression (8) for d₁^{AB*} yields

$${c}^{*} = c \frac{{s}_{1}^{B} - {t}_{1}^{A}}{{t}_{2}^{A} - {s}_{1}^{B}} . \qquad ( 15 )$$

Substitution of expression (7) for s₁^{B}, followed by algebraic simplification, gives

$${c}^{*} = \frac{c}{ξ} . \qquad ( 16 )$$

By solving expression (12) for ξ in terms of vᵣ^{AB*} and substituting into (16), the final result is

c*=c−vᵣ^{AB*}. (17)

This result is important in the synchronization of clock C, which will now be described. It will also be used in the method of synchronization using one-way signal transmissions, to be described later.

Using Clock B to Synchronize Clock C with Clock A

Clock C can now be synchronized to clock A by receiving a one-way downlink signal transmission from B with a message containing the transmission time s^{B} according to synchronized clock B, and ephemeris data which permits determination of the velocity vector \overline{v}^{B} and the position of clock B at time s^{B} in the coordinate frame containing clocks A and C. Since the position of clock C is precisely known, the radial velocity vᵣ^{CB} and starred distance d^{CB*} from C to B can be determined at time s^{B}. Let the arrival time of the signal as measured by unsynchronized clock C be denoted by t^{C}. The signal arrival time s^{C} measured when clock C is properly synchronized is given by

$${s}^{C} = {s}^{B} + \frac{{d}^{{CB}^{*}}}{c - {v}_{r}^{CB}} . \qquad ( 18 )$$

Clock C may now be synchronized to clock B (hence to clock A) by one of two methods:

Method 1: Add the correction ε^{C}=s^{C}−t^{C} to any unsynchronized time of clock C.

Method 2: Reset clock C by incrementing its indicated time by ε^{C} seconds.

Synchronization Using One-Way Signal Transmissions

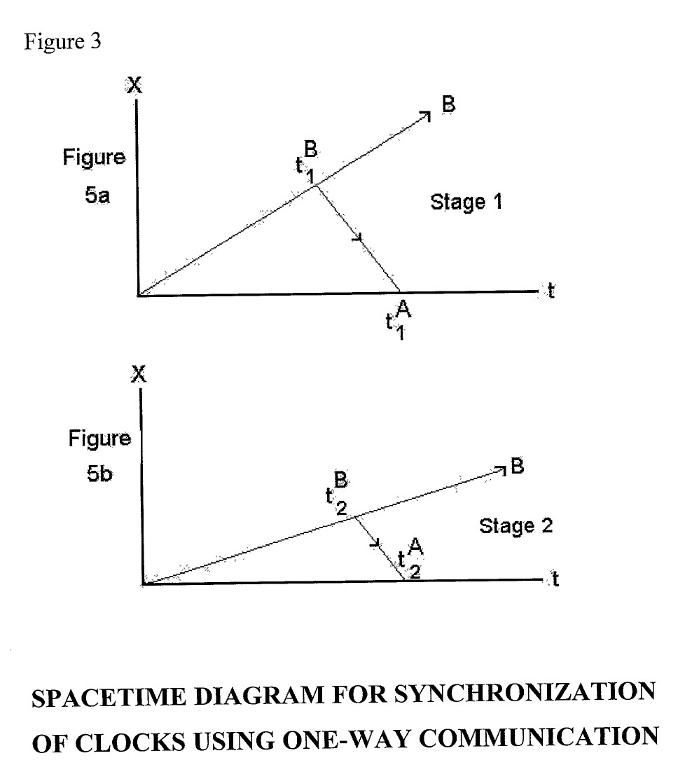

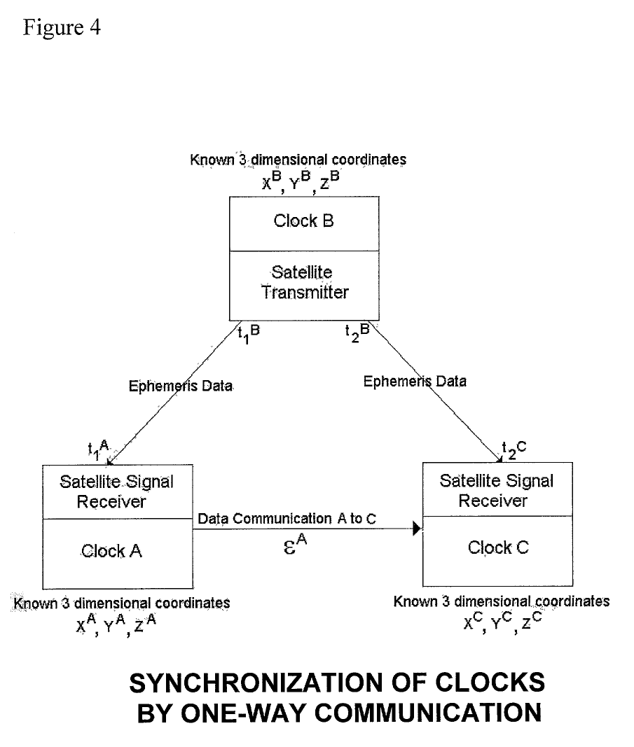

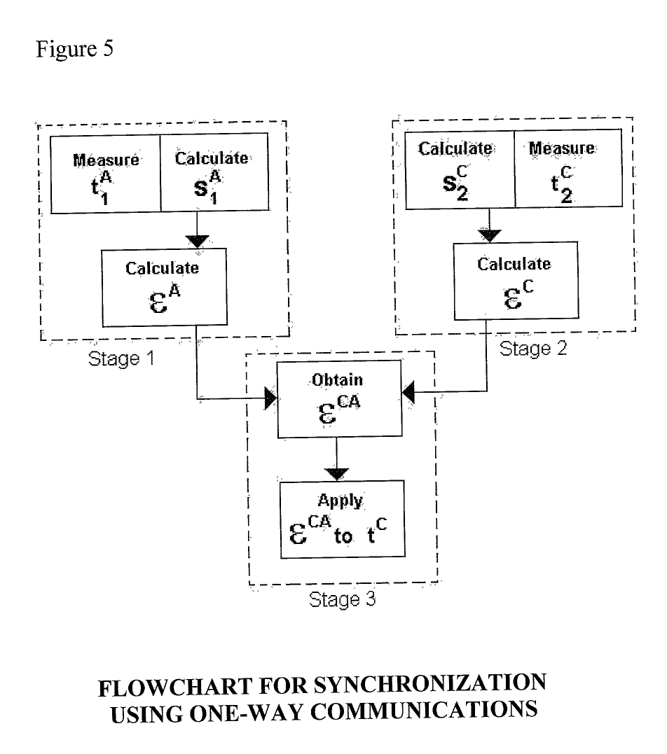

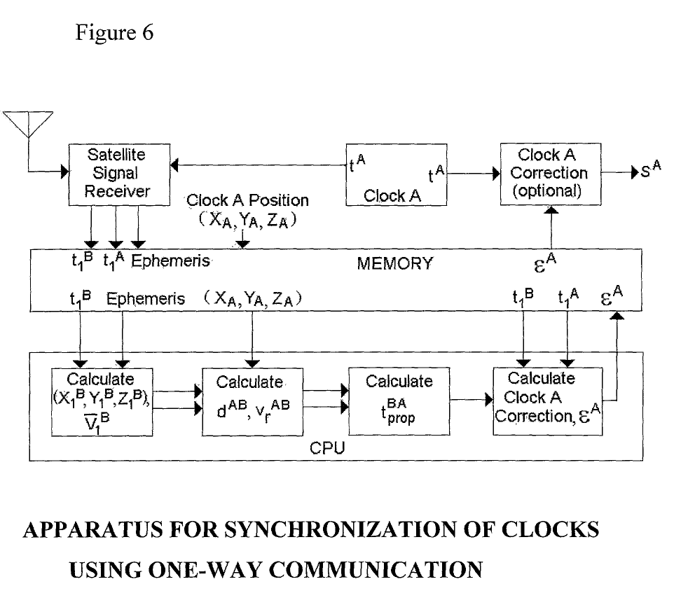

Understanding of the following explanation will be aided by reference to FIGS. 3, 4, 5 and 6. Synchronization of two clocks using only one-way signal transmission from a third clock is also possible using the concepts of this invention. Here the two clocks to be synchronized will be denoted by A and C, and the third clock by B. A radio receiver is co-located with clock A and a radio receiver is also co-located with clock C. Co-located with clock B is a transmitter.

For simplicity of explanation, clocks A and C are assumed to be at rest with precisely known locations within a three-dimensional coordinate system fixed to the earth, and clock B may be moving within this system. A typical coordinate system is the GPS Earth-Centered, Earth Fixed (ECEF) system with orthogonal x-, y-, and z-axes meeting at an origin located at earth's center. The coordinates of clocks A, B, and C will be denoted respectively by (x^{A}, y^{A},z^{A}), (x^{B}, y^{B},z^{B}),and (x^{C}, y^{C}, z^{C}).

Clock B broadcasts a radio signal which can be received by clocks A and C. The signal contains a navigation message with satellite ephemeris data which permits A and C to know the precise location (x^{B}, y^{B}, z^{B}) and velocity vector \overline{v}^{B} of clock B within the ECEF coordinate system at every moment of time as read by clock B. The signal also contains periodically occurring identifiable points in the signal structure called epochs, and the navigation message contains information which permits clocks A and C to identify the precise transmission time of each epoch according to clock B.

Synchronization of clock C with clock A can be accomplished in a procedure that, for convenience, can be defined as having three stages.

Stage 1 could be defined as a process for determining a correction for clock A that would be needed at clock A as if clock A was to be synchronized to satellite clock B. That correction is defined as ε^{A}. Stage 1 consists of calculations which normally take place at clock A. FIG. 3 is a block diagram of an apparatus for performing the calculations of stage 1.

Stage 2 could be defined as a process for determining a correction for clock C that would be needed at clock C as if clock C was to be synchronized with satellite clock B. That correction is defined as ε^{B}. Stage 2 consists of calculations that are similar to those of stage 1 and which normally take place at clock B and stage 2 uses an apparatus identical to that used for stage 1 for the stage 2 calculations, so FIG. 3 can also be used as a block diagram for the stage 2 calculations by changing every occurrence of the superscript A to superscript B.

Stage 3 defines a process of determining a correction term to be applied to clock C to directly synchronize it with clock A. That correction term is ε^{CA}.

Stage 1:

Clock A receives the signal broadcast from clock B and records the time t₁^{A} of reception of a specific epoch according to clock A. Clock A also extracts from the navigation message and records the time t₁^{B} of transmission of the epoch according to clock B. It should be noted that time as indicated by clock B is proper time, that is, it is uncorrected for relativistic effects, and does not need to be synchronized with clock A. Clock A uses the ephemeris data contained in the received signal to calculate the precise location (x₁^{B}, y₁^{B}, z₁^{B}) and velocity vector \overline{v}₁^{B}=(v₁ₓ^{B}, v_{1y}^{B}, v_{1z}^{B}) of B at the moment t₁^{B} of epoch transmission.

At clock A the distance d^{AB} from clock A to clock B at the moment t₁^{B} of epoch transmission is calculated:

$${d}^{AB} = \sqrt{{( {x}_{1}^{B} - {x}^{A} )}^{2} + {( {y}_{1}^{B} - {y}^{A} )}^{2} + {( {z}_{1}^{B} - {z}^{A} )}^{2}} . \qquad ( 19 )$$

Also calculated is the radial component vᵣ^{AB} of relative velocity between A and B (the component which lies along the line of sight from A to B) according to the formula

vAB B u AB (20)

where \overline{u}^{AB} is a unit vector pointing along the line of sight from A to B at the moment of epoch transmission, and the dot indicates the dot (or inner) product of the two vectors. A positive value of vᵣ^{AB} corresponds to a distance from A to B which is increasing with time. An alternative method of determining vᵣ^{AB} is to compute it by measuring the signal Doppler shift Δf in Hertz at clock A and using the formula

$$\begin{matrix}{v}_{r}^{AB} = - λ ( Δ f ) \\ = - c \frac{Δ f}{f} ,\end{matrix} \qquad ( 21 )$$

where f is the carrier frequency transmitted by the satellite, λ is the corresponding wavelength at the propagation speed c of light in free space. A positive value of Δf corresponds to negative value of vᵣ^{AB}.

At clock A the propagation time of the signal epoch in traveling from B to A is calculated according to the formula

$${t}_{prop}^{BA} = \frac{{d}^{AB}}{c - {v}_{r}^{AB}} . \qquad ( 22 )$$

This formula is different from common practice in that the denominator is not the speed of light, but the speed of light reduced by the relative radial velocity of the satellite. The reason for this difference is that, in common practice, an attempt is made to correct the readings of clock B for relativistic effects of satellite motion and earth rotation relative to an inertial frame, prior to computing the propagation time tₚᵣₒₚ^{BA}. However, such corrections are unnecessary and lead to misapplication of the Lorentz transformations developed by Einstein. By using only proper times (i.e., uncorrected times of freely running clocks) and regarding time as absolute, no corrections of the satellite clock is necessary, but the formula for tₚᵣₒₚ^{BA} changes to that shown above.

An epoch arrival time s₁^{A} at clock A is now calculated, which is based on clock B's transmission time and the signal propagation time, in contrast to the direct measurement of arrival time t₁^{A} by clock A:

$$\begin{matrix}{s}_{1}^{A} = {t}_{1}^{B} + {t}_{prop}^{BA} \\ = {t}_{1}^{B} + \frac{{d}^{AB}}{c - {v}_{r}^{AB}} .\end{matrix} \qquad ( 23 )$$

The last step in the calculation at clock A is to compute the correction term

ε^{A}=s₁^{A}−t₁^{A} (24)

for clock A. At this point, clock A could be synchronized to clock B in the satellite if desired, either by adding ε^{A} to any unsynchronized reading of clock A, or by resetting clock A by incrementing its reading by ε^{A} as soon as ε^{A} has been determined.

However, if clock A is itself a time reference station, such a synchronization would not normally be performed.

Stage 2:

Stage 2 is identical in all respects to the calculations made by clock A, except that the calculations use data from the signal as received at clock C. FIG. 3 serves as a block diagram of an apparatus for performing these calculations if every occurrence of superscript A is replaced with superscript C.

Clock C receives the signal broadcast from clock B and records the time t₂^{C} of reception of a specific epoch according to clock C. This epoch may be the same epoch record by clock A, or it may be a different epoch. Also the epoch could be transmitted before or after the epoch used by clock A. Clock C also extracts from the navigation message and records the time t₂^{B} of transmission of the epoch according to clock B. Clock C uses the ephemeris data contained in the received signal to calculate the precise location (x₂^{B}, y₂^{B}, z₂^{B}) and velocity vector \overline{v}₂^{B}=(v₂ₓ^{B}, v_{2y}^{B}, v_{2z}^{B}) of B at the moment t₂^{B} of epoch transmission.

At clock C the distance d^{CB} from clock C to clock B at the moment t₂^{B} of epoch transmission is calculated:

$${d}^{CB} = \sqrt{{( {x}_{2}^{B} - {x}^{C} )}^{2} + {( {y}_{2}^{B} - {y}^{C} )}^{2} + {( {z}_{2}^{B} - {z}^{C} )}^{2}} , \qquad ( 25 )$$

Also calculated is the radial component vᵣ^{CB} of relative velocity between clock C and clock B according to the formula

vᵣ^{CB}=\overline{v}₂^{B}·\overline{u}^{CB}, (26)

where \overline{u}^{CB} is a unit vector pointing along the line of sight from clock C to clock B at the moment of epoch transmission, and the dot indicates the dot (or inner) product of the two vectors. A positive value of vᵣ^{CB} corresponds to a distance from clock C to clock B which is increasing with time. An alternative method of determining vᵣ^{CB} is to compute it by measuring the signal Doppler shift Δf in Hertz at clock C and using the formula

$$\begin{matrix}{v}_{r}^{CB} = - λ ( Δ f ) \\ = - c \frac{Δ f}{f} ,\end{matrix} \qquad ( 27 )$$

where f is the carrier frequency transmitted by the satellite, λ is the corresponding wavelength at the propagation speed c of light in free space. A positive value of Δf corresponds to negative value of vᵣ^{CB}.

At clock C the propagation time of the signal epoch in traveling from clock B to clock C is calculated according to the formula

$${t}_{prop}^{BC} = \frac{{d}^{CB}}{c - {v}_{r}^{CB}} . \qquad ( 28 )$$

An epoch arrival time s₂^{C} at clock C is now calculated, which is based on clock B's transmission time t₂^{B} and the signal propagation time, in contrast to the direct measurement of arrival time t₂^{C} by clock C:

$$\begin{matrix}{s}_{2}^{C} = {t}_{2}^{B} + {t}_{prop}^{BC} \\ = {t}_{2}^{B} + \frac{{d}^{CB}}{c - {v}_{r}^{CB}} .\end{matrix} \qquad ( 29 )$$

The last step in clock C's calculations is to compute the correction term

ε^{C}=s₂^{C}−t₂^{C} (30)

for clock C.

Stage 3:

At this point, clock C could be synchronized to clock B in the satellite if desired, either by adding ε^{C} to any unsynchronized reading of clock C, or resetting clock C by incrementing its reading by ε^{C} as soon as ε^{C} has been determined.

In order to synchronize clock C to clock A, the correction term ε^{CA} is computed as follows:

ε^{CA=ε}^{C}−ε^{A}. (31)

The synchronization may be performed adding ε^{CA} to any unsynchronized reading of clock C, t^{C}, or resetting clock C from t^{C} by incrementing its reading by ε^{CA} after ε^{CA} has been determined. Normally the calculation of ε^{CA} is performed at clock C; in that case the value of ε^{A} (or the measurements at clock A required to calculate it) would be communicated from clock A to clock C by an independent communications link.

Therefore the synchronized time of clock C to clock A is given by:

S^{C}=t^{C}+ε^{CA} (32)

In other words, the synchronization use of ε^{CA} may be implemented in either of 2 ways:

1. Clock C may simply be reset according to ε^{CA}; or

2. Clock C is allowed to continue its prior readings which are modified by adding ε^{CA} to its reading and using the result as a synchronized time from clock C.

For example, in the GPS, the satellite broadcasts the set reading of its clock plus a correction term and the user receiver applies the correction term to the set reading to achieve a corrected time.

Although particular embodiments of the invention have been described and illustrated herein, it is recognized that modifications and variations may readily occur to those skilled in the art, and consequently it is intended that the claims be interpreted to cover such modifications and equivalents.

1. A method of synchronizing a plurality of clocks at different locations using a third clock (clock B) comprising the steps of:
determining a correction term, ε^{A} for a first one of the plurality of clocks (clock A) the correction term being the difference between the computed arrival time of a signal from clock B to clock A if clock A was synchronized to clock B, defined as s₁^{A}, minus the observed time by clock A of arrival of the signal from clock B at clock A;
determining a correction term, ε^{C} for any selected one or ones of the plurality of clocks (clocks C) to be synchronized, the correction term being the difference between the computed arrival time of a signal from clock B to clock C if clock C was synchronized to clock B, defined as s₂^{A} minus the observed time by clock C of arrival of the signal from clock B at clock C;
applying the difference between the correction terms, ε^{A} and ε^{C}, defining a correction term, ε^{CA} for clock C, to synchronize the selected one or ones of the plurality of clocks C for which ε^{C} has been determined, to clock A.

2. The method of claim 1 wherein s₁^{A} computed according to:
$${s}_{1}^{A} = {t}_{1}^{B} + \frac{{d}^{AB}}{c - {v}_{r}^{AB}}$$
where;
t₁^{B} the time of transmission of the signal from clock B according to clock B;
d^{AB} is the distance from clock A to clock B at the time t₁^{B};
c is the velocity of light in a vacuum;
vᵣ^{AB} is the radial velocity of clock B relative to clock A at the time t₁^{B};

3. The method of claim 1 wherein clock B is in a GPS satellite and the signal from the satellite has ephemeris data to allow calculation of d_{AB} and vᵣ^{AB}.

4. The method of claim 3 wherein clocks A and C are on the earth.

5. The method of claim 3 wherein clock A is on the earth and clock C is on a satellite and clock C has its position and velocity computed timely for calculation of ε^{C}.

6. The method of claim 3 wherein clock A is on a satellite and clock C is on a satellite and both clock A and clock C have their position and velocity computed timely for calculation ε^{A} and ε^{C} respectively.

7. A method of synchronizing a plurality of clocks at different locations on earth using a clock in a satellite that is in translation relative to the clocks on earth, where an arbitrary one of the clocks on earth is referred to as clock A and an arbitrary other of the clocks on earth is referred to as clock C, and the clock in the satellite is referred to as clock B, and where the process can be used with a single defined clock A, or by designating any clock of the plurality of clocks as clock A, and any other of the clocks of the plurality of clocks as clock B comprising the steps of;
stage 1, at clock A
receiving the signal from clock B;
recording the time t₁^{A}, of reception of a specific epoch according to clock A;
recording the time t₁^{B}, of transmission of the epoch according to clock B;
determining the location, x₁^{B}, y₁^{B}, z₁^{B}, and velocity vector \overline{v}₁^{B}, of B at the time t₁^{B}, of the epoch transmission;
determining the radial component vᵣ^{AB} of relative velocity between clock A and clock B;
determining at clock A the propagation time of the signal epoch in traveling from A to B, tₚᵣₒₚ^{BA};
determining the epoch arrival time s^{A}, at clock A;
determining the correction term for clock A, ε^{A};
stage 2, at clock B
receiving the signal from clock B;
recording the time t₂^{C} of reception of a specific epoch according to clock C;
recording the time t₂^{B} of transmission of the epoch according to clock B;
determining the location x₂^{B}, y₂^{B}, z₂^{B}, and the velocity vector \overline{v}₂^{B} of B at the time t₂^{B} of the specific epoch transmission;
determining the radial component vᵣ^{CB} of relative velocity between clock C and clock B;
determining at clock C the propagation time of the signal epoch in traveling from clock B to clock C, tₚᵣₒₚ^{BC};
determining the epoch arrival time, s₂^{C} at clock C;
determining correction term for clock C, ε^{C};
stage 3, at clock C
differencing the correction term ε^{C} and ε^{A} to determine ε^{CA};
synchronizing clock C to clock A by applying ε^{CA} to the unsynchronized reading of clock C.

8. The method of claim 7 wherein s₁^{A} is computed according to:
$${s}_{1}^{A} = {t}_{1}^{B} + \frac{{d}^{AB}}{c - {v}_{r}^{AB}}$$
where;
t₁^{B} is the time of transmission of the signal from clock B according to clock B;
d^{AB} is the distance from clock A to clock B at the time t₁^{B};
c is the velocity of light in a vaccum;
vᵣ^{AB} is the radial velocity of clock B relative to clock A at the time t₁^{B};

9. The method of claim 7 wherein clock B is in a GPS satellite and the signal from the satellite has ephemeris data to allow calculation of d^{AB} and vᵣ^{AB}.

10. The method of claim 7 wherein clocks A and C are on the earth.

11. The method of claim 7 wherein clock A is on the earth and clock C is on a satellite and clock C has its position and velocity computed timely for calculation of ε^{C}.

12. The method of claim 7 wherein clock A is on a satellite and clock C is on a satellite and both clock A and clock C have their position and velocity computed timely for calculation ε^{A} and ε^{C} respectively.

13. A method of synchronizing a clock in a satellite to a clock on the earth, comprising the steps of:
transmitting a signal S_{w} from a first clock (clock A) at time t₁^{A} according to clock A;
recording at clock A the time t₁^{A} of transmission of signal S_{w}.
recording at the location of the clock in the satellite (clock B) the time t₁^{B} that signal S_{w} is received by clock B;
at time t₁ or at a time known relative to time t₁^{B}, transmitting a signal Sₓ from the
satellite, said signal Sₓ containing a message indicating the value of t₁^{B};
recording at clock A the time t₂^{A} that signal Sₓ is received by clock A, and
recording the value of t₁^{B} from the message contained in signal Sₓ;
at time t₂^{A} or at a time known relative to time t2^{A}, transmitting a signal S_{y} from clock A;
receiving the signal at clock B at time t₁^{B} according to clock B;
at time t₂^{B} or at a time known relative to time t₂^{B}, transmitting a signal S_{z} from clock B;
recording at clock A the time t₃^{A} that signal S_{z} is received by clock A;
determining the characteristic value ξ of relative motion according to the expression
$$ξ = {( \frac{{t}_{3}^{A} - {t}_{2}^{A}}{{t}_{2}^{A} - {t}_{1}^{A}} )}^{\frac{1}{2}} ;$$
obtaining the synchronized time s₁^{B} of reception of signal S_{w} according to the formula
$${s}_{1}^{B} = \frac{1}{ξ + 1} ( {t}_{2}^{A} + ξ {t}_{1}^{A} ) ;$$
determining a correction term ε^{B}, which is s₁^{B}−t₁^{B};
sending the value of ε^{B} to the satellite and having the satellite broadcast the value of ε^{B} along with its unsynchronized time t^{B}, or sending the value of ε^{B} to the satellite and having the satellite use ε^{B} in conjunction with t^{B} to broadcast a synchronized time.

14. A method of synchronizing a clock in a satellite to a clock on the earth, comprising the steps of:
transmitting a signal S_{w} from a reference clock (clock A) at time t₁^{A} according to clock A, said signal S_{w} containing a message indicating the value of t₁^{A};
recording at the location of the clock in the satellite (clock B) the time t₁^{B} that signal S_{w} is received by clock B, and recording the value of t₁^{A} from the message contained in signal S_{w};
at time t₂^{B} or at a time known relative to time t₁^{B}, transmitting a signal Sₓ from the satellite;
recording at clock A the time t₁^{B} that signal Sₓ is received by clock A;
at time t₂^{A} or at a time known relative to time t₂^{A}, transmitting a signal S_{y} from clock A, said signal S_{y} containing a message indicating the value of t₂^{A};
recording at clock B the time t₂^{B} that signal S_{y} is received by clock B, and recording the value of t₂^{A} from the message contained in signal S_{y};
determining the characteristic value ξ of relative motion according to the expression
$$ξ = \frac{{t}_{2}^{B} - {t}_{1}^{B}}{{t}_{2}^{A} - {t}_{1}^{A}} ;$$
obtaining the synchronized time s₁^{B} of reception of signal S_{w} according to the formula
$${s}_{1}^{B} = \frac{1}{ξ + 1} ( {t}_{2}^{A} + ξ {t}_{1}^{A} ) ;$$
determining a correction term ε^{B}, which is s₁^{B}−t₁^{B};
having the satellite broadcast the value of ε^{B} along with its unsynchronized time t^{B}, or sending the value of ε^{B} to the satellite and having the satellite use ε^{B} in conjunction with t^{B} to broadcast a synchronized time.
